(19) United States
(12) Patent Application Publication
(10) Pub. No.: US 2003/0100367 A1
(43) Pub. Date: May 29, 2003

(54) Feedback assembly for computer games

(76) Inventor: Michael Charles Cooke, Ascot (AU)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/979,357

(22) PCT Filed: May 19, 2001
(86) PCT No.: PCT/AU00/00481

(30) Foreign Application Priority Data
May 21, 1999 (AU) PQ 0478

(51) Int. Cl. A63F 13/00

(52) U.S. Cl. 463/36

(57) ABSTRACT

A feedback assembly for computer games, the feedback assembly having an output means for delivering stimulation signals to simulate muscles of part of a players body, an input means for receiving stimulation signals from a signal generator and an attachment means adapted to attach the output means to a part of the players body, wherein in use the output means is adapted to deliver stimulation signals in response to the activation signals received from the input means at predetermined times to represent events occurring in an activity involving the player.

### FIELD OF THE INVENTION

The present invention relates primarily to computer games and in particular to computer games which may be connected through a console to a television or VGA monitor.

### BACKGROUND OF THE INVENTION

A typical type of computer game includes a computer console which is adapted to receive computer game software in the form of a cartridge or CD.

A game controller is connected to the console and can be in the form of a joy stick, mouse or other specifically designed game controller which is able to perform various functions within the computer game which is displayed.

There is a continuing desire among computer game manufacturers and players for games to be produced which are as realistic as possible. To this end computer game graphics are constantly improving in accordance with increasing memory capacity and processing power of most computers.

Furthermore game controllers have improved to simulate real life situations.

As an example a person can play a formula 1 racing car game using a game controller in the form of a steering wheel and foot operable pedals. Further improvements include feedback signals being provided to the steering wheel of the game controller so as to adjust the resistance to turning of the steering wheel. Accordingly if during play of a computer game a person crashes into another car, feedback signals are delivered to the steering wheel to simulate the reaction to the steering wheel from the impact with another car in the computer game.

The problem with the steering wheel game controller as described above lies primarily with its limitation to a particular type of game. Most games however do not require a person to be seated and often a player is controlling movement of a character within the computer game.

The present invention is aimed at improving the realism of computer games for the player.

### SUMMARY OF THE INVENTION

According to the present invention there is provided a feedback assembly for computer games, the feedback assembly having an output means for delivering stimulation signals to stimulate muscles of part of a players body, an input means for receiving stimulation signals from a signal generator and an attachment means adapted to attach the output means to a part of the players body, wherein in use the output means is adapted to deliver stimulation signals at predetermined times in response to the stimulation signals received from the input means, to represent events occurring in an activity involving the player.

Preferably the input means comprises an input device for connection to an interface means for interconnecting the input means and a data processor used for controlling the activity involving the player.

The stimulation signals are preferably delivered so as to create the impression that the player receives muscle stimulation whenever an event occurs during the activity involving the player, which event represents a “bit” or a “virtual impact” to the player during the activity.

The present invention is chiefly directed to a feedback assembly for use with computer games but is equally applicable to other computer generated activities such as computer simulations and training activities. For example a car driving simulator may be used in conjunction with the feedback assembly, whereby every time the simulated vehicle driven by the player makes a virtual impact feedback signals are delivered back to a data processor and the feedback assembly may be adapted to deliver stimulation signals whenever such feedback signals are received by the data processor.

In such a situation the feedback assembly acts as a simulator whereby the “player” receives muscle stimulation as a result of the stimulation signal whenever a virtual impact takes place during the simulation.

Preferably the feedback assembly comprises at least one accessory which is able to be worn by the player.

According to one embodiment the feedback assembly comprises a plurality of accessories which are adapted to be worn on different limbs of the player.

It is preferred that the output means comprises a plurality of wearable accessories.

At least one accessory may comprise a casing with the output means on an inner surface thereof.

It is preferred that the output means comprises one or more electrodes.

The casing may be adapted to at least partially wrap around a part of a player's body.

Preferably the casing is adapted to wrap around a person's limb.

The casing may be generally annular in shape.

The casing preferably comprises a strap-on member.

The casing preferably comprises flexible material which is able to be worn on a person's limb or torso.

The casing may be a flexible strap.

The casing preferably includes a plurality of electrodes.

Preferably each of the electrodes is able to be activated independently of the others so as to provide the activation assembly with the ability to transmit stimulation signals at different locations. Such an arrangement may be desired or necessary in order to avoid the player becoming tolerant or unreceptive to signals transmitted by the activation assembly.

The degree of realism for the feedback assembly may be increased by increasing the number of accessories which are strapped to parts of the players body. Particular electrodes may then be stimulated which are in locations corresponding to the part of the virtual character, the player is being represented by, which receive a virtual impact. Thus for example in a virtual fighting game if a virtual character in a computer game receives a blow to the leg or arm, electrodes in contact with the players leg and arm are activated to deliver stimulation signals in those areas at approximately the same time the virtual impact was received by the character played by the player.

Preferably the feedback assembly includes the signal generator.

The input means is preferably wired to the output means.

The feedback assembly preferably includes the interface means.

The interface means may comprise an interface unit having a housing with a feedback assembly input port(s) for connection to one or more outputs of the output means.

The output means preferably comprises an output plug for each accessory.

According to another embodiment the input means is adapted to receive stimulation signals through wireless transmission from the signal generator.

The interface unit may include adjustment means for varying at least one parameter of the stimulation signal. These parameters may include amplitude, period and frequency of current or voltage.

The adjustment means may be controlled independently by a person or automatically by the data processor.

The interface means may include sensor means for sensing feedback signals transmitted by the data processor to an output device such as an audible alarm or “rumble pack”.

It is preferred that the sensor means is adapted to transmit signals to a signal generator processor in response to the feedback signals sensed, whereby the signal generator processor is adapted to control the signal generator to generate stimulation signals.

The interface means may be in the form of a single unit which is either an add on unit to an existing game console or instead may be part of an integrated game console.

Alternatively the interface unit may be an accessory or card which is able to be connected to a PC via an external port or via internal means such as a mother board.

The interface means may comprise a controller for controlling which electrode delivers a stimulation signal.

The feedback assembly may include electrical wires connected between the or each casing and the interface means.

The interface means may include accessory input and output ports and a data processor output port for interconnecting the interface means to a data processor.

Preferably the interface means comprises a computer game console.

The interface means may include a joystick/mouse or other controller input/output port adapted to interconnect a controller with the data processor. In such an embodiment the controllers would control operation of the data processor. The interface means preferably includes a data processor which is adapted to be connected to a main data processor.

It is preferred that each accessory is adapted to place the output means in close contact with the skin of the player.

The output means desirably is able to stimulate muscles of the player.

The main data processor may be a computer console for a computer game.

It is preferred that the interface means is in the form of an interface unit which has electrical wires connected to the activation assembly and one or more electrical wires which are removably connectable to a port of a game console or other data processor for a computer game.

The interface means is preferably adapted to deliver a stimulation signal to an output means controller which is then adapted to control the output means to transmit the stimulation signal to the adjacent part of the player's body.

The stimulation signal transmitted from the output means, although preferably electrical, may be magnetic, acoustic or static electricity or any other signal which is able to be sensed by the person to which the activation assembly is attached.

It is preferred that the interface means is able to receive a feedback signal from the main data processor and in response to this signal is able to transmit one or more pulses to the output means for transmission to the player's body.

According to another aspect of the present invention there is provided a feedback assembly for computer games, the feedback assembly having at least one sensor for sensing a stress characteristic of a person, an attachment means adapted to attach the sensor to a part of a person's body, and a controller including a receiver which is adapted to process stress indicator signals received from the sensor means and utilise the stress signals to produce an output which is capable of affecting the functioning/or control of a computer activity.

It is preferred that the output signals are arranged to be used by a computer program to produce a display on a display means.

It is preferred that the output signals are indicative of the level of stress indicators of the person and a representation of this level of stress is able to be displayed on a display means.

It is preferred that the controller comprises computer software for running a computer game.

Alternatively the controller includes software for a training and/or rehabilitation program which is able to be displayed on a display means such as a VDU.

According to one embodiment of the present invention signals received from the sensor(s) are fed into a computer console which processes the signals in a fashion whereby a computer generated display of stress levels of the person being sensed is able to be displayed on a display device such as a VDU.

It is preferred that the controller includes an amplification means for amplifying signals received from the sensor(s).

It is preferred that the sensor(s) is hardwired to output connectors which are able to be connected to ports of a device including the controller.

The sensor means may be adapted to measure galvonic skin resistance, blood pressure, muscle loading, heart rate, skin temperature, brain wave patterns, respiration, smell and perspiration or any other stress indicators of a person.

According to another embodiment of the present invention the feed back assembly includes a means of generating a display on a display means, which display provides a graphic or video representation of various stress level indicators of a person being sensed.

Accordingly one embodiment the feedback assembly includes software for controlling a computer game, which computer game is affected by the level of stress sensed by the sensor means. For example the game may produce outputs on a visual indicator, which warn a player playing the game that stress levels of the player must be reduced in order to proceed to a next phase of the game.

According to another embodiment of the present invention there is provided a feedback assembly incorporating an output means for delivery of stimulation signals to stimulate muscles of part of player's body, an input means for receiving stimulation signals from a signal generator, sensor means for sensing stress indicators of the player and an attachment means adapted to attach the output means and sensor means to a part of the player's body, wherein in use the output means is adapted to deliver stimulation signals at predetermined times in response to the stimulation signals received from the input means, to represent events occurring in an activity involving the player and the sensor means is adapted to sense stress indicators of the player and deliver stress indicator signals to a controller whereby the activity is able to produce a response in reply to the stress indicator signals.

Optionally the feedback assembly has one or more of the preferred features recited above.

According to one example of the present invention there is provided a training simulation computer program which is able to be used in conjunction with the feedback assembly to monitor stress indicator signals of a person and provide a visual display of stress parameters of the person.

It is preferred that the feedback assembly includes a plurality of players each having an output means for delivering stimulation signals attached to a part of their body.

Preferably each player is connected to the same controller or data processor whereby stimulation signals may be delivered to one or more of the players in accordance with events occurring during an activity being controlled by the controller or data processor.

It is preferred that the feedback assembly includes a means for displaying stress indicator information and/or stimulation signal information on a display.

According to another embodiment of the present invention the interface unit includes a means for sensing a player's response to stimulation signals, whereby the strength of stimulation signals can be varied so that each player in a multi-player application of the present invention is able to experience the same degree of stimulation of muscles. Thus as an example if a person with particularly thick skin does not sense stimulation signals as easily as someone with thin skin the intensity of stimulation signals can be increased correspondingly to compensate for this lack of sensing by the thick skin person.

It is preferred that the feed back assembly includes a means for measuring a player's response to stimulation signals in order to gauge the person's sensitivity to the strength of those stimulation signals whereby the strength of the stimulation signals can be increased or decreased so that each player in a multiplayer application of the assembly is able to experience the same degree of stimulation of muscles.

The interface unit preferably includes a skin resistance measurement means or similar device whereby the player's response to stimulation signals is able to be recorded and processed so as to allow adjustment of the intensity of stimulation signals delivered to the player.

### BRIEF DESCRIPTION OF THE DRAWINGS

A preferred embodiment of the present invention will now be described by way of example only with reference to the accompanying drawings in which:

FIG. 1 shows a perspective view of a feedback assembly for computer games according to a first embodiment of the present invention;

FIG. 2 shows a top view of a feedback assembly for computer games according to a second embodiment of the present invention;

FIG. 3 shows a perspective view of a feedback assembly for computer games according to a third embodiment of the present invention;

FIG. 4 shows one circuit diagram which is applicable to a feedback apparatus according to the second embodiment of the present invention;

FIG. 5 shows strap-on electrode units attached to a player;

FIG. 6A shows a side view of a strap-on electrode unit for the feedback assembly according to any one of the previous feedback assemblies;

FIG. 6B shows a top sectional view of the electrode unit shown in FIG. 6A;

FIG. 6C shows a perspective view of the electrode unit shown in FIGS. 6A and 6B;

FIG. 7A shows a side view of an electrode unit according to a second embodiment of the present invention;

FIG. 7B shows a top sectional view of the electrode unit shown in FIG. 7A;

FIG. 7C shows a perspective view of the electrode unit shown in FIG. 7B;

FIG. 8A shows a side view of an electrode unit according to a third embodiment of the present invention;

Figure BB shows a top sectional view of the electrode unity shown in Figure BA; and

FIG. 8C shows a perspective view of the electrode unit shown in FIG. 8B.

### DETAILED DESCRIPTION OF THE DRAWINGS

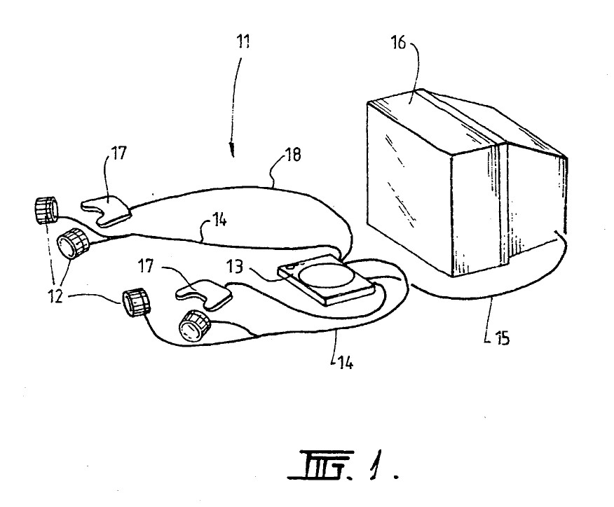

As shown in FIG. 1 a feedback assembly 11 consists of a number of strap-on electrode units 12 which are hardwired back to a central console 13 through wiring 14. The console 13 is connected through wiring 15 to a television monitor 16.

Game controller devices 17 are hardwired through wiring 18 to the console 13.

The console 13 in this embodiment includes gaming software which is able to be added through memory storage devices such as CD rom or cartridges.

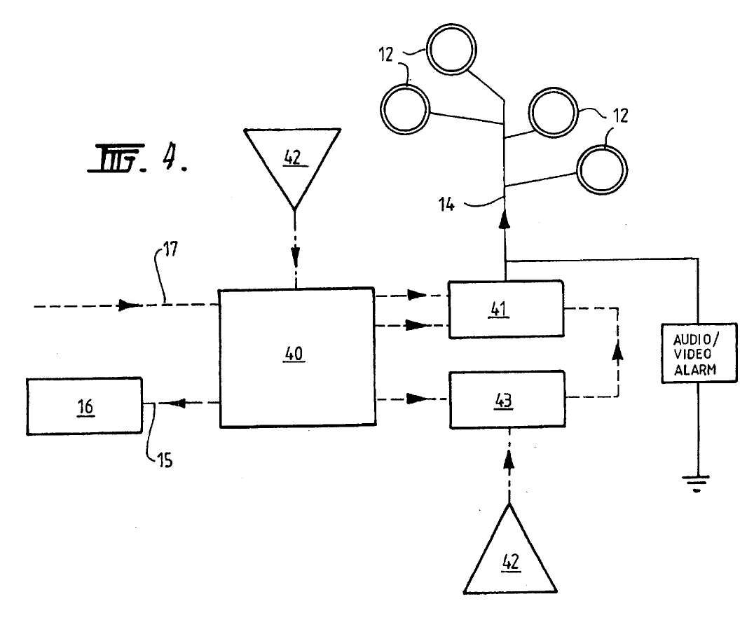

As shown in FIGS. 6A to 8C the electrode units 12 are desirably annular strips of neoprene strap or moulded plastic with an inner surface provided with electrodes 20, 21, 22.

FIGS. 6A to 8C show three different embodiments for the electrodes 20, 21 and 22. In FIG. 8A a number of electrodes are equispaced around the inner surface 23 of the unit 12 at both ends of the unit 12.

Accordingly two rings of electrodes are provided on the inner periphery 23 so as to completely encircle the area covered by the limb on which the unit 12 is placed.

In FIGS. 6A to 6C the electrodes 20 are in the form of parallel conductive strips, again at both ends of the unit 12.

According to another embodiment the electrodes may be provided only on a semicircular section of the annular unit 12.

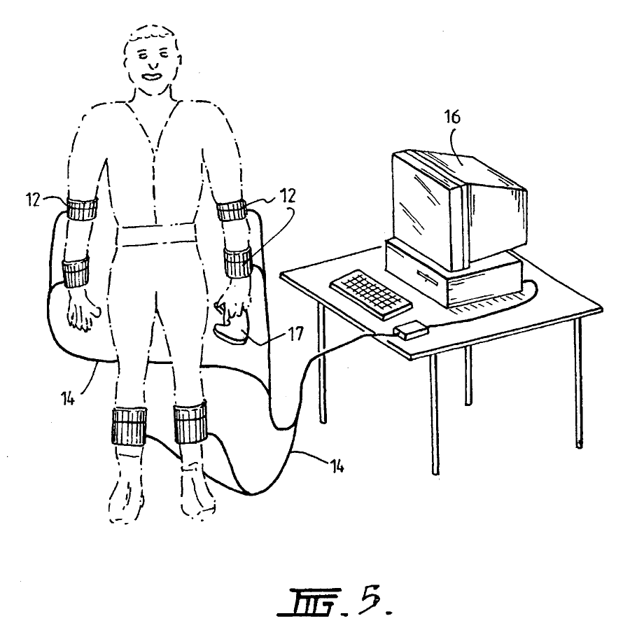

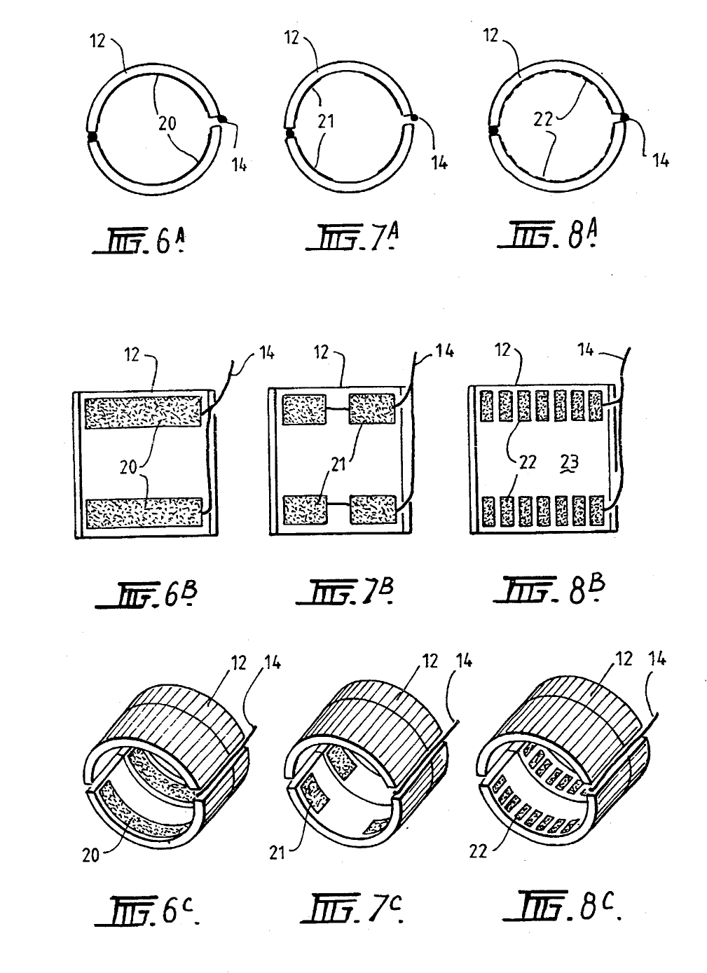

In FIGS. 7A to 7C four electrodes are provided, two at each end of the unit 12.

The electrodes may be independently connected to wiring back to the console 13 or may be connected together and hardwired through a single wire back to the console 13.

The units 12 may be moulded as a single annular piece or may be formed as a flexible article which is wrapped around a person's limb and strapped on by any suitable anchoring mechanism such as a hook and loop connection system.

Assuming there are two players the units 12 can be strapped onto each person's arms or legs and the console can be switched on to play a game.

Operation of the game controller 17 can control characters within the game displayed on the television screen and if the game involves using weapons against another character, the feedback assembly provides a method of feeling a sensation when a “hit” is received by a player's character. Thus if a character is shot in the leg the console hardware and software records the hit and transmits a signal to the appropriate electrode unit to transmit a signal in the form of an electrical pulse to the adjacent skin of the player. The result is an effective jolt to that person as the electrical signal which is transmitted to the person's skin stimulates muscle tissue and evokes some form of involuntary response equivalent to a hit on the player.

The levels of voltage which are used in the game are low enough so that there is no possibility of any harm being inflicted on the player other than the stimulation of muscle tissue.

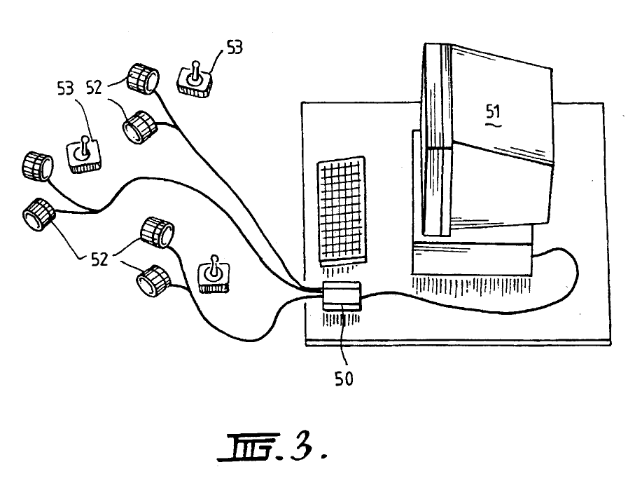

As shown in FIG. 5 it is preferred that the feedback assembly is provided with a number of electrode units which are able to be strapped onto various parts of the player.

The greater the number of electrode units which are connected the greater the area of the player's body which can be covered so that “hits” that occur on a character in the video game can be transmitted as “hits” to similar parts of the player's body.

As shown in FIG. 2 an intermediate control unit 30 may be provided to receive all the input connections from the electrodes units 12 and the game controller 17. The intermediate unit 30 is then connected through wiring 31 to the console 32. In this embodiment it is not necessary to custom make the console 32 as in the first embodiment with console 13. Instead the intermediate device 30 can be connected to a standard console 32 through a normal peripheral input/output port.

The intermediate unit 30 would ideally have electronic componentry which is able to receive transmitted signals from the console representing “hits”, and the location of the “hits” and these signals would be processed in the intermediate unit 30 which would then transmit a suitable electrical pulse to the electrodes of the electrode units 12 to provide a stimulation signal to the appropriate part of the player's body that corresponds to that of the characters body.

As shown in FIG. 4 the circuitry required to effect the above described feedback assembly, consists of a data and control processor 40 which in the embodiment shown in FIG. 2 would be located inside the intermediate unit 30.

The data and control processor would be connected to an output driver 41 also inside the intermediate unit 30 which in turn would be wired through wiring 14 to the respective electrode units 12.

Power to the data and control processor and the output driver 40 can be supplied through a power source connected directly to a unit housing these components, such as an intermediate unit 30, or alternately may be supplied through the wiring 31 from the console 32.

Depending upon the required voltage levels within the intermediate unit 30, a power converter 43 may be provided which is connected between the output driver and the data and control processor, with the power source 42 also applied to the power converter 43.

If the data and control processor is located within the console 32, then visual and audio display data is transmitted directly from this unit 40 to the television monitor 16.

According to an alternative embodiment the data and control processor 40 and output driver 41 and power converter 43 could in part include a transcutaneous electrical neural stimulation device (TENS). This is a currently available integrated circuit chip which is used in the medical field to relieve pain. The signals which are delivered by this device would be similar to those used in the preferred embodiment of the present invention.

A preferred pulse which would be delivered by the output driver 42 would have the following characteristics:

12-80 volts.

40-100 microsecond pulse width.

2 to 221 Hz.

According to the embodiments previously described electronic pulses are delivered by electronic componentry which is remote from the electrode units 12. However the present invention includes the possibility of electrical stimulation circuitry being included within the electrode unit 12. For example the electronic circuit may be in the form of a computer chip which is embedded inside the casing of the article which houses the electrodes on its inner surface.

The embodiments which have been described above are concerned mainly with gaming consoles which are connected to television monitors.

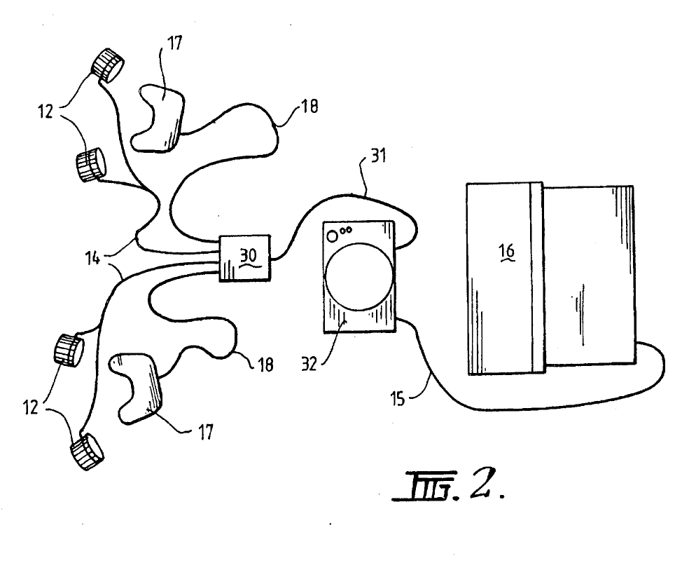

The present invention however includes other embodiments in which a central control unit 50 as shown in FIG. 3 is connected to the CPU of a computer 51. In a similar fashion to the previously described embodiments, the electrode units 52 and game controllers 53 are connected to input ports of the controller 50.

1. A feedback assembly for computer games, the feedback assembly having an output means for delivering stimulation signals to simulate muscles of part of a players body, an input means for receiving stimulation signals from a signal generator and an attachment means adapted to attach the output means to a part of the players body, wherein in use the output means is adapted to deliver stimulation signals, in response to the activation signals received from the input means at predetermined times to represent events occurring in an activity involving the player.

2. The feedback assembly as claimed in claim 1 wherein the output means is adapted to deliver stimulation signals at predetermined times corresponding to the times at which feedback signals are received by a data processor with the feedback signals representing events occurring in the activity.

3. The feedback assembly as claimed in claim 1 wherein the predetermined times correspond to the times during the activity during which the player receives a simulated impact.

4. The feedback system as claimed in claim 1 wherein the input means comprises an input device for connection to an interface means for interconnecting the input means and a data processor used for controlling an activity involving the player.

5. The feedback assembly as claimed in claim 4 wherein the activation assembly comprises at least one accessory which is able to be worn by the player.

6. The feedback assembly as claimed in claim 5 wherein the at least one accessory comprises a casing with the output means on an inner surface thereof.

7. The feedback assembly as claimed in claim 6 wherein the output means comprises one or more electrodes.

8. The feedback assembly as claimed in claim 7 wherein the casing is adapted to wrap around a persons limb.

9. The feedback assembly as claimed in claim 8 wherein the attachment means comprises a strap and hook and loop system.

10. The feedback assembly as claimed in claim 9 including a plurality of wearable accessories each having at least one electrode which is able to deliver stimulation signals independently of each other electrode.

11. The feedback assembly as claimed in claim 10 wherein the input means is wired to the output means.

12. The feedback system as claimed in claim 1 including an interface means which includes the signal generator.

13. The feedback assembly as claimed in claim 12 wherein the interface means includes the signal generator.

14. The feedback assembly as claimed in claim 13 wherein the interface means comprises an interface unit having a housing with at least one feedback assembly input port for receipt of the input means.

15. The feedback assembly as claimed in claim 14 wherein the interface unit includes accessory input and output ports and a data processor output port for connecting the interface means to a data processor.

16. The feedback assembly as claimed in claim 15 wherein the accessory input and output ports are adapted to connect the interface unit to at least one controller for controlling operation of the data processor.

17. The feedback assembly as claimed in claim 16 wherein the interface unit is adapted to be connected to a computer console of a computer game.

18. The feedback assembly as claimed in claim 14 wherein the interface means includes a data processor for producing a computer generated activity on a display device.

19. The feedback assembly as claimed in claim 18 wherein the signal generator is adapted to be controlled by an adjustment means to vary a parameter of the stimulation signals so as to vary the stimulation signals delivered by the output means to simulate different events occurring during the activity played by the player.

20. The feedback assembly as claimed in claim 19 wherein the stimulation signals vary in amplitude in direct proportion to the amplitude of the feedback signals.
